(19) United States
(12) Patent Application Publication
(10) Pub. No.: US 2010/0329876 A1
(43) Pub. Date: Dec. 30, 2010

(54) NICKEL-BASE SUPERALLOYS AND COMPONENTS FORMED THEREOF

(75) Inventors: Kenneth Rees Bain, Loveland, OH (US); David Paul Mourer, Beverly, MA (US)

Correspondence Address: HARTMAN AND HARTMAN, P.C., 552 EAST 700 NORTH, VALPARAISO, IN, 46383, US

(73) Assignee: GENERAL ELECTRIC COMPANY, Schenectady, NY (US)

(21) Appl. No.: 12/494,806

(22) Filed: Jun. 30, 2009

(51) Int. Cl. B64C 27/46; C22C 19/05

(52) U.S. Cl. 416/223 R; 420/449; 420/448

(57) ABSTRACT

Gamma prime nickel-base superalloy and components formed therefrom. The alloy contains, by weight, 11.3 to 13.3% cobalt, 12.4 to 15.2% chromium, 2.1 to 2.7% aluminum, 3.6 to 5.8% titanium, 3.5 to 4.5% tungsten, 3.1 to 3.8% molybdenum, 0.0 to 1.2% niobium, 0.0 to 2.3% tantalum, 0.0 to 0.5% hafnium, 0.040 to 0.100% carbon, 0.010 to 0.046% boron, 0.030 to 0.080% zirconium, the balance nickel and impurities, wherein the Nb+Ta content is 0.0-3.5%.

### BACKGROUND OF THE INVENTION

The present invention generally relates to nickel-base alloy compositions, and more particularly to nickel-base superalloys suitable for components requiring a polycrystalline microstructure and high temperature dwell capability, for example, turbine disks of gas turbine engines.

The turbine section of a gas turbine engine is located downstream of a combustor section and contains a rotor shaft and one or more turbine stages, each having a turbine disk (rotor) mounted or otherwise carried by the shaft and turbine blades mounted to and radially extending from the periphery of the disk. Components within the combustor and turbine sections are often formed of superalloy materials in order to achieve acceptable mechanical properties while at elevated temperatures resulting from the hot combustion gases. Higher compressor exit temperatures in modern high pressure ratio gas turbine engines can also necessitate the use of high performance nickel superalloys for compressor disks, blisks, and other components. Suitable alloy compositions and microstructures for a given component are dependent on the particular temperatures, stresses, and other conditions to which the component is subjected. For example, airfoil components such as blades and vanes are often formed of equiaxed, directionally solidified (DS), or single crystal (SX) superalloys, whereas turbine disks are typically formed of superalloys that must undergo carefully controlled forging, heat treatments, and surface treatments such as peening to produce a polycrystalline microstructure having a controlled grain structure and desirable mechanical properties.

Turbine disks are often formed of gamma prime (γ′) precipitation-strengthened nickel-base superalloys (hereinafter, gamma prime nickel-base superalloys) containing chromium, tungsten, molybdenum, rhenium and/or cobalt as principal elements that combine with nickel to form the gamma (γ) matrix, and contain aluminum, titanium, tantalum, niobium, and/or vanadium as principal elements that combine with nickel to form the desirable gamma prime precipitate strengthening phase, principally Ni₃(Al,Ti). Particularly notable gamma prime nickel-base superalloys include René 88DT (R88DT; U.S. Pat. No. 4,957,567) and René 104 (R104; U.S. Pat. No. 6,521,175), as well as certain nickel-base superalloys commercially available under the trademarks Inconel®, Nimonic®, and Udimet®. R88DT has a composition of, by weight, about 15.0-17.0% chromium, about 12.0-14.0% cobalt, about 3.5-4.5% molybdenum, about 3.5-4.5% tungsten, about 1.5-2.5% aluminum, about 3.2-4.2% titanium, about 0.5.0-1.0% niobium, about 0.010-0.060% carbon, about 0.010-0.060% zirconium, about 0.010-0.040% boron, about 0.0-0.3% hafnium, about 0.0-0.01 vanadium, and about 0.0-0.01 yttrium, the balance nickel and incidental impurities. R104 has a nominal composition of, by weight, about 16.0-22.4% cobalt, about 6.6-14.3% chromium, about 2.6-4.8% aluminum, about 2.4-4.6% titanium, about 1.4-3.5% tantalum, about 0.9-3.0% niobium, about 1.9-4.0% tungsten, about 1.9-3.9% molybdenum, about 0.0-2.5% rhenium, about 0.02-0.10% carbon, about 0.02-0.10% boron, about 0.03-0.10% zirconium, the balance nickel and incidental impurities. Another notable gamma prime nickel-base superalloy is disclosed in European Patent Application EP1195446, and has a composition of, by weight, about 14-23% cobalt, about 11-15% chromium, about 0.5-4% tantalum, about 0.5-3% tungsten, about 2.7-5% molybdenum, about 0.25-3% niobium, about 3-6% titanium, about 2-5% aluminum, up to about 2.5% rhenium, up to about 2% vanadium, up to about 2% iron, up to about 2% hafnium, up to about 0.1% magnesium, about 0.015-0.1% carbon, about 0.015-0.045% boron, about 0.015-0.15% zirconium, the balance nickel and incidental impurities.

Disks and other critical gas turbine engine components are often forged from billets produced by powder metallurgy (P/M), conventional cast and wrought processing, and spraycast or nucleated casting forming techniques. Gamma prime nickel-base superalloys formed by powder metallurgy are particularly capable of providing a good balance of creep, tensile, and fatigue crack growth properties to meet the performance requirements of turbine disks and certain other gas turbine engine components. In a typical powder metallurgy process, a powder of the desired superalloy undergoes consolidation, such as by hot isostatic pressing (HIP) and/or extrusion consolidation. The resulting billet is then isothermally forged at temperatures slightly below the gamma prime solvus temperature of the alloy to approach superplastic forming conditions, which allows the filling of the die cavity through the accumulation of high geometric strains without the accumulation of significant metallurgical strains. These processing steps are designed to retain the fine grain size originally within the billet (for example, ASTM 10 to 13 or finer), achieve high plasticity to fill near-net-shape forging dies, avoid fracture during forging, and maintain relatively low forging and die stresses. In order to improve fatigue crack growth resistance and mechanical properties at elevated temperatures, these alloys are then heat treated above their gamma prime solvus temperature (generally referred to as supersolvus heat treatment) to cause significant, uniform coarsening of the grains.

Though alloys such as R88DT and R104 have provided significant advances in high temperature capabilities of superalloys, further improvements are continuously being sought. For example, high temperature dwell capability has emerged as an important factor for the high temperatures and stresses associated with more advanced military and commercial engine applications. As higher temperatures and more advanced engines are developed, creep and crack growth characteristics of current alloys tend to fall short of the required capability to meet mission/life targets and requirements of advanced disk applications. It has become apparent that a particular aspect of meeting this challenge is to develop compositions that exhibit desired and balanced improvements in creep and hold time (dwell) fatigue crack growth rate characteristics at temperatures of 1200° F. (about 650° C.) and higher, while also having good producibility and thermal stability. However, complicating this challenge is the fact that creep and crack growth characteristics are difficult to improve simultaneously, and can be significantly influenced by the presence or absence of certain alloying constituents as well as relatively small changes in the levels of the alloying constituents present in a superalloy.

### BRIEF DESCRIPTION OF THE INVENTION

The present invention provides gamma prime nickel-base superalloys and components formed therefrom that exhibit improved high-temperature dwell capabilities, including creep and hold time fatigue crack growth behavior.

According to a first aspect of the invention, a gamma-prime nickel-base superalloy consists of, by weight, 11.3 to 13.3% cobalt, 12.4 to 15.2% chromium, 2.1 to 2.7% aluminum, 3.6 to 5.8% titanium, 3.5 to 4.5% tungsten, 3.1 to 3.8% molybdenum, 0.0 to 1.2% niobium, 0.0 to 2.3% tantalum, 0.0 to 0.5% hafnium, 0.040 to 0.100% carbon, 0.010 to 0.046% boron, 0.030 to 0.080% zirconium, the balance nickel and impurities, wherein the Nb+Ta content is 0.0-3.5%.

Other aspects of the invention include various components that can be formed from the alloys described above, particular examples of which include turbine disks and compressor disks and blisks of gas turbine engines.

A significant advantage of the invention is that the nickel-base superalloys described above provide the potential for balanced improvements in high temperature dwell properties, including improvements in both creep and hold time fatigue crack growth rate (HTFCGR) characteristics at temperatures of 1200° F. (about 650° C.) and higher, while also having good producibility and good thermal stability. Improvements in other properties are also believed possible, particularly if appropriately processed using powder metallurgy, hot working, and heat treatment techniques.

Other aspects and advantages of this invention will be better appreciated from the following detailed description.

### BRIEF DESCRIPTION OF THE DRAWINGS

FIG. 1 is a perspective view of a turbine disk of a type used in gas turbine engines.

FIG. 2 is a table listing a series of nickel-base superalloy compositions initially identified by the present invention as potential compositions for use as a turbine disk alloy.

FIG. 3 is a table compiling various predicted properties for the nickel-base superalloy compositions of FIG. 2 if subjected to a two-step heat treatment.

FIG. 4 is a graph plotting creep and hold time fatigue crack growth rate from the data of FIG. 3.

FIG. 5 is a table compiling various predicted properties for the nickel-base superalloy compositions of FIG. 2 if subjected to a one-step heat treatment.

FIG. 6 is a graph plotting creep and hold time fatigue crack growth rate from the data of FIG. 5.

FIG. 7 a table listing actual chemistries a series of nickel-base superalloy compositions prepared on the basis of the alloys initially identified in FIG. 2.

### DETAILED DESCRIPTION OF THE INVENTION

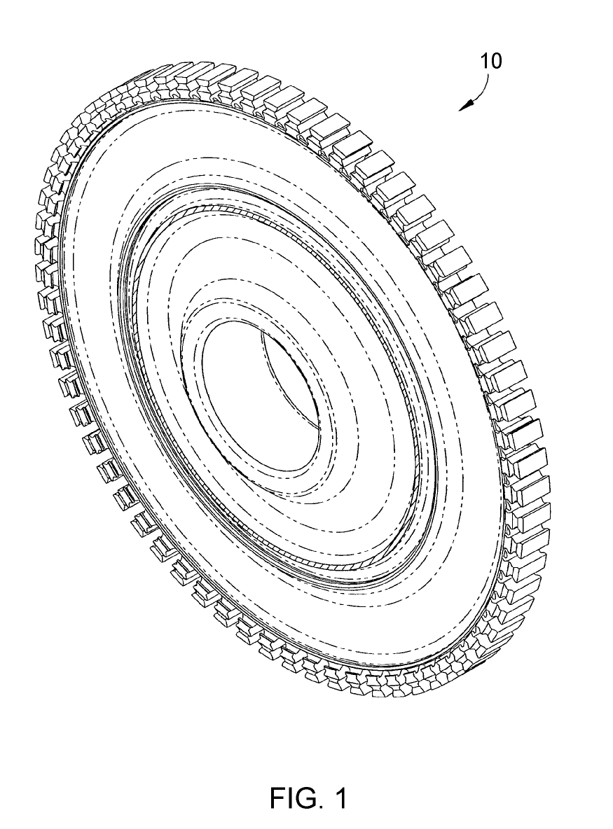

The present invention is directed to gamma prime nickel-base superalloys, and particular those suitable for components produced by a hot working (e.g., forging) operation to have a polycrystalline microstructure. A particular example represented in FIG. 1 is a high pressure turbine disk 10 for a gas turbine engine. The invention will be discussed in reference to processing of a high-pressure turbine disk for a gas turbine engine, though those skilled in the art will appreciate that the teachings and benefits of this invention are also applicable to compressor disks and blisks of gas turbine engines, as well as numerous other components that are subjected to stresses at high temperatures and therefore require a high temperature dwell capability.

Disks of the type shown in FIG. 1 are typically produced by isothermally forging a fine-grained billet formed by powder metallurgy (PM), a cast and wrought processing, or a spraycast or nucleated casting type technique. In a preferred embodiment utilizing a powder metallurgy process, the billet can be formed by consolidating a superalloy powder, such as by hot isostatic pressing (HIP) or extrusion consolidation. The billet is typically forged at a temperature at or near the recrystallization temperature of the alloy but less than the gamma prime solvus temperature of the alloy, and under superplastic forming conditions. After forging, a supersolvus (solution) heat treatment is performed, during which grain growth occurs. The supersolvus heat treatment is performed at a temperature above the gamma prime solvus temperature (but below the incipient melting temperature) of the superalloy to recrystallize the worked grain structure and dissolve (solution) the gamma prime precipitates in the superalloy. Following the supersolvus heat treatment, the component is cooled at an appropriate rate to re-precipitate gamma prime within the gamma matrix or at grain boundaries, so as to achieve the particular mechanical properties desired. The component may also undergo aging using known techniques.

Superalloy compositions of this invention were developed through the use of a proprietary analytical prediction process directed at identifying alloying constituents and levels capable of exhibiting better high temperature dwell capabilities than existing nickel-base superalloys. More particularly, the analysis and predictions made use of proprietary research involving the definition of elemental transfer functions for tensile, creep, hold time (dwell) crack growth rate, density, and other important or desired mechanical properties for turbine disks produced in the manner described above. Through simultaneously solving of these transfer functions, evaluations of compositions were performed to identify those compositions that appear to have the desired mechanical property characteristics for meeting advanced turbine engine needs, including creep and hold time fatigue crack growth rate (HTFCGR). The analytical investigations also made use of commercially-available software packages along with proprietary databases to predict phase volume fractions based on composition, allowing for the further definition of compositions that approach or in some cases slightly exceed undesirable equilibrium phase stability boundaries. Finally, solution temperatures and preferred amounts of gamma prime and carbides were defined to identify compositions with desirable combinations of mechanical properties, phase compositions and gamma prime volume fractions, while avoiding undesirable phases that could reduce in-service capability if equilibrium phases sufficiently form due to in-service environment characteristics. In the investigations, regression equations or transfer functions were developed based on selected data obtained from historical disk alloy development work. The investigations also relied on qualitative and quantitative data of the aforementioned nickel-base superalloys R88DT and R104.

Particular criteria utilized to identify certain potential alloy compositions included the desire for an alloy with low cycle fatigue (LCF) behavior similar to or better than R88DT, but with improved high temperature hold time (dwell) behavior and with a greater volume percentage of gamma prime ((Ni,Co)₃(Al,Ti,Nb,Ta)) to promote strength at temperatures of 1400° F. (about 760° C.) and higher over extended periods of time. In addition, certain compositional parameters were identified as potential modifications to the R88DT composition, including higher levels of hafnium for high temperature strength, more optimal boron levels, and additions of tantalum. Alloys within this group are identified herein as alloys 08-03 through 08-10. Finally, regression factors relating to specific mechanical properties were utilized to more narrowly identify potential alloy compositions that might be capable of exhibiting superior high temperature hold time (dwell) behavior, and would not be otherwise identifiable without extensive experimentation with a very large number of alloys. Such properties included ultimate tensile strength (UTS) at 1200° F. (about 650° C.), yield strength (YS), elongation (EL), reduction of area (RA), creep (time to 0.2% creep at 1200° F. and 115 ksi (about 650° C. at about 790 MPa), hold time (dwell) fatigue crack growth rate (HTFCGR; da/dt) at 1300° F. (about 700° C.) and a maximum stress intensity of 25 ksi√ in (about 27.5 MPa√ m), fatigue crack growth rate (FCGR), gamma prime volume percent (GAMMA′ %) and gamma prime solvus temperature (SOLVUS), all of which were evaluated on a regression basis. Units for these properties reported herein are ksi for UTS and YS, percent for EL, RA and gamma prime volume percent, hours for creep, in/sec for crack growth rates (HTFCGR and FCGR), and ° F. for gamma prime solvus temperature. Thermodynamic calculations were also performed to assess alloy characteristics such as phase volume fraction, stability and solvii for gamma prime, carbides, borides and topologically close packed (TCP) phases.

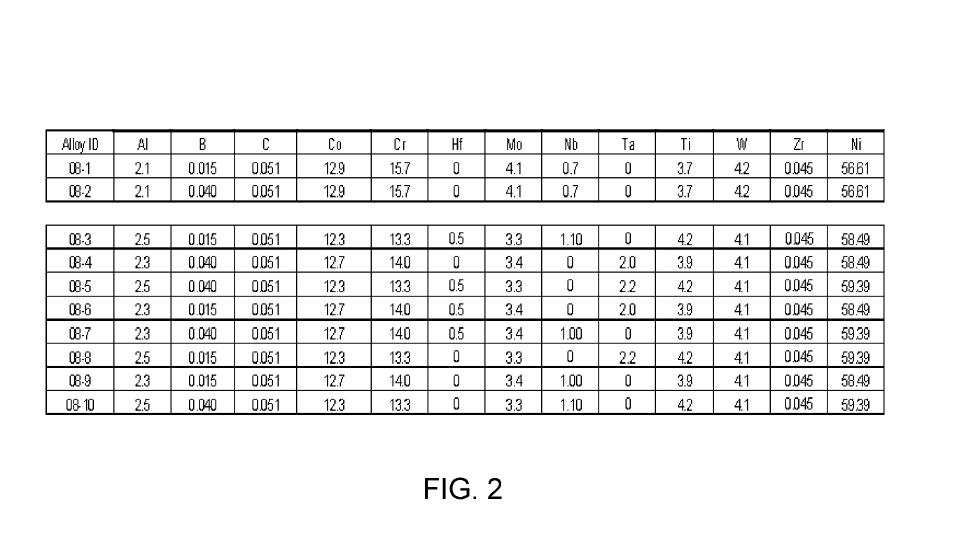

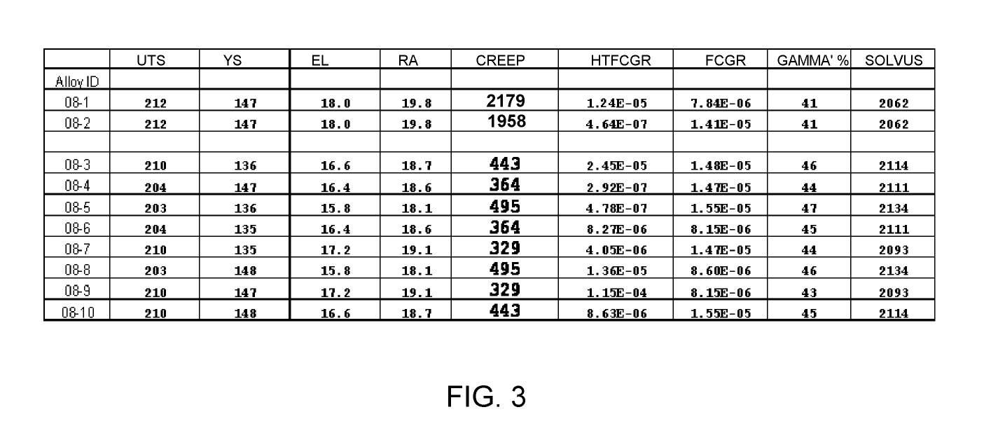

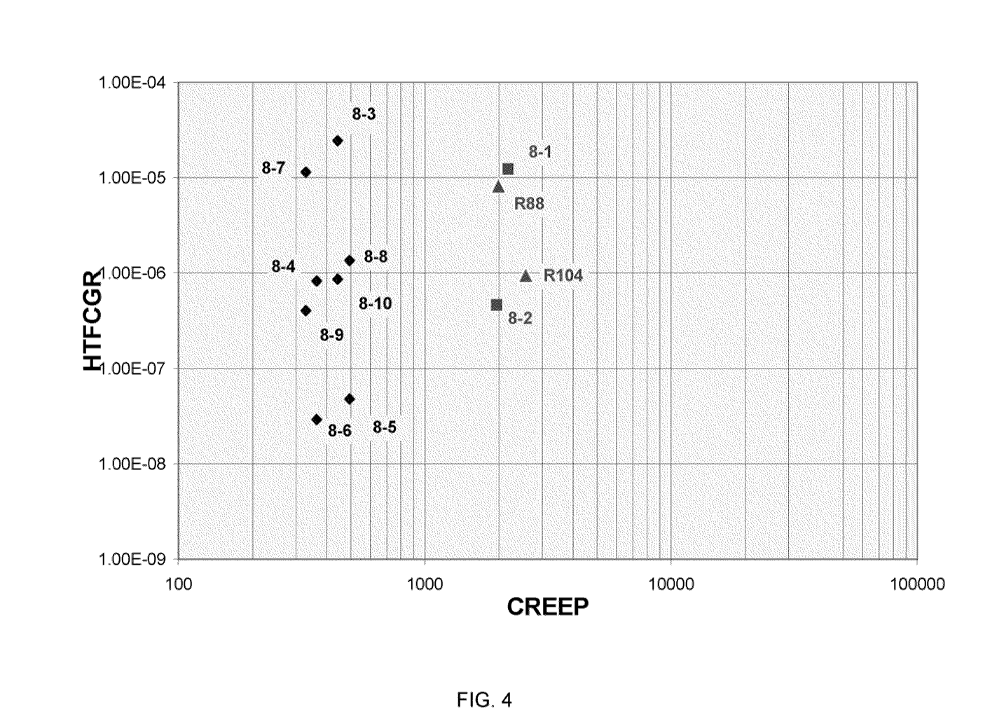

The process described above was performed iteratively utilizing expert opinion and guidance to define preferred compositions for manufacture and evaluation. From this process, the above-noted series of alloy compositions 08-03 to 08-10 were defined (by weight percent) as set forth in the table of FIG. 2. For reference, also included in the table are two alloys (08-01 and 08-02) that fall within the composition of R88DT but with minimum or maximum amounts of boron. Regression-based property predictions for the alloys of FIG. 2 are contained in a table in FIG. 3, and FIG. 4 contains a graph of the hold time fatigue crack growth rate (HTFCGR) and creep data from FIG. 3. The predictions are based on utilization of a stabilization style two-step age heat treatment at about 1550° F. (about 845° C.) for about four hours, followed by about eight hours at about 1400° F. (about 760° C.).

For reference, FIG. 4 also contains historical HTFCGR and creep data for R88DT and R104. From the visual depiction of FIG. 4, it can be seen that a higher boron level appears to improve the HTFCGR behavior of R88DT, though not its creep properties. As to the proposed alloy compositions, it appeared that 08-04, 08-05, and 08-07 may yield improvements in HTFCGR behavior as compared to the historical level for R88DT.

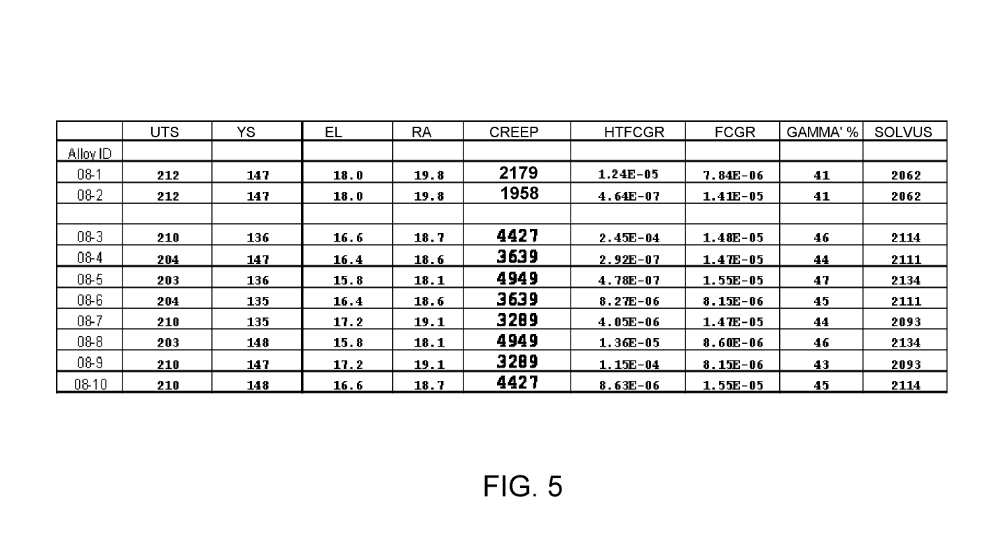

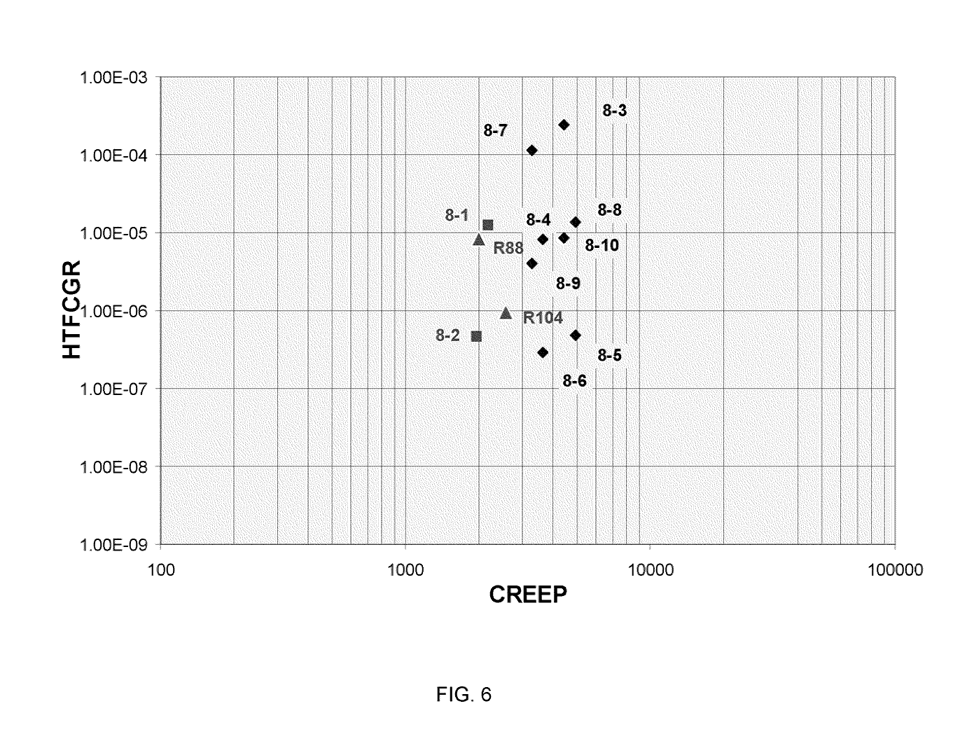

The alloys of FIG. 2 then underwent further regression-based property predictions based on utilization of a one-step age heat treatment. The resulting property predictions are contained in a table in FIG. 5, and FIG. 6 contains a graph of the HTFCGR and creep data from FIG. 5. For reference, FIG. 6 also contains historical HTFCGR and creep data for R88DT and R104. As in the previous predictions based on a two-step heat treatment, from FIG. 6 it can be seen that a higher boron level appears to improve the HTFCGR behavior of R88DT though not its creep properties. As to the proposed alloy compositions, it appeared that 08-04, 08-05, and 08-07 may again yield improvements in HTFCGR behavior as compared to the historical level for R88DT, as well as improvements in creep behavior.

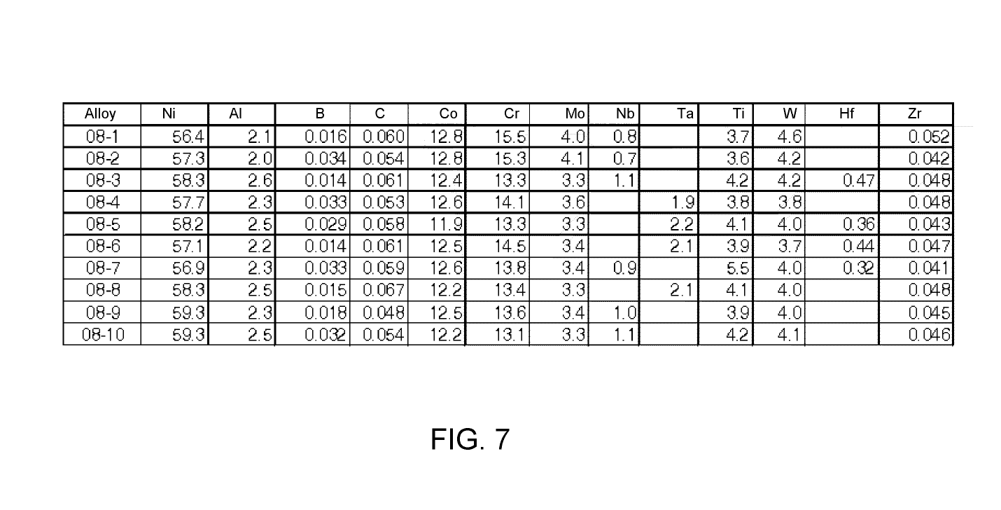

Alloys based on each of the compositions analyzed and discussed above were then prepared. Actual chemistries (in weight percent) of the prepared alloys are summarized in a table in FIG. 7. From these alloys, an alloy range was identified to define an alloy with promising properties, and with a narrowly defined range that reflects the properties predicted for the analyzed alloy composition. Broader and narrower ranges for an alloy encompassing alloys 08-03 through 08-10 are summarized in Table I below and characterized in part by (in comparison to R88DT) relatively low chromium levels, relatively high titanium, hafnium and tantalum+niobium levels, and the preference for tantalum over niobium. The “With Ta & Hf” column in Table I is intended to focus on those alloys of 08-03 to 08-10 that contain tantalum and hafnium. In addition to the elements listed in Table I, it is believed that minor amounts of other alloying constituents could be present without resulting in undesirable properties. Such constituents and their amounts (by weight) include up to 2.5% rhenium, up to 2% vanadium, up to 2% iron, and up to 0.1% magnesium.

TABLE I

| | Broader | Narrower | With Ta & Hf |
|---|---|---|---|
| Co | 11.3-13.3 | 11.9-12.7 | 11.7-12.7 |
| Cr | 12.4-15.2 | 13.1-14.5 | 12.8-14.5 |
| Al | 2.1-2.7 | 2.2-2.6 | 2.2-2.6 |
| Ti | 3.6-5.8 | 3.8-5.5 | 3.8-5.5 |
| W | 3.5-4.5 | 3.7-4.2 | 3.7-4.2 |
| Mo | 3.1-3.8 | 3.3-3.6 | 3.2-3.7 |
| Nb | 0.0-1.2 | 0.0-1.1 | 0.0 |
| Ta | 0.0-2.3 | 0.0-2.2 | 1.0-2.2 |
| Hf | 0.0-0.5 | 0.0-0.5 | 0.3-0.5 |
| C | 0.040-0.100 | 0.048-0.067 | 0.048-0.067 |
| B | 0.010-0.046 | 0.014-0.040 | 0.014-0.040 |
| Zr | 0.030-0.080 | 0.041-0.070 | 0.041-0.070 |
| Ni | Balance | Balance | Balance |
| Nb + Ta | 0.0-3.5 | 0.09-2.2 | 1.0-2.2 |

Though the alloy compositions identified in FIGS. 2 and 7 and the alloys and alloying ranges identified in Table I were all based on analytical predictions, the extensive analysis and resources relied on to make the predictions and identify these alloy compositions provide a strong indication for the potential of these alloys, and particularly the alloy compositions of Table I, to achieve significant improvements in creep and hold time fatigue crack growth rate characteristics desirable for turbine disks of gas turbine engines.

While the invention has been described in terms of particular embodiments, including particular compositions and properties of nickel-base superalloys, the scope of the invention is not so limited. Instead, the scope of the invention is to be limited only by the following claims.

1. A gamma-prime nickel-base superalloy consisting of, by weight:
11.3 to 13.3% cobalt;
12.4 to 15.2% chromium;
2.1 to 2.7% aluminum;
3.6 to 5.8% titanium;
3.5 to 4.5% tungsten;
3.1 to 3.8% molybdenum;
0.0 to 1.2% niobium;
0.0 to 2.3% tantalum;
0.0 to 0.5% hafnium;
0.040 to 0.100% carbon;
010 to 0.046% boron;
030 to 0.080% zirconium;
the balance nickel and impurities, wherein the Nb+Ta content is 0.0-3.5%.

2. The gamma-prime nickel-base superalloy according to claim 1, wherein the titanium content is greater than 4.2%.

3. The gamma-prime nickel-base superalloy according to claim 1, wherein the molybdenum content is less than 3.5%.

4. The gamma-prime nickel-base superalloy according to claim 1, wherein the niobium content is less than 0.5%.

5. The gamma-prime nickel-base superalloy according to claim 1, wherein the tantalum content is at least 1%.

6. The gamma-prime nickel-base superalloy according to claim 1, wherein the hafnium content is greater than 0.3%.

7. The gamma-prime nickel-base superalloy according to claim 1, wherein the Nb+Ta content is greater than 1.0%.

8. The gamma-prime nickel-base superalloy according to claim 1, wherein the gamma-prime nickel-base superalloy consists of, by weight, 11.7 to 12.7% cobalt, 12.8 to 14.5% chromium, 2.2 to 2.6% aluminum, 3.8 to 5.5% titanium, 3.7 to 4.2% tungsten, 3.2 to 3.7% molybdenum, 0.0 niobium, 1.0 to 2.2% tantalum, 0.3 to 0.5% hafnium, 0.048 to 0.067% carbon, 0.014 to 0.040% boron, 0.041 to 0.070% zirconium, the balance nickel and impurities.

9. A component formed of the gamma-prime nickel-base superalloy of claim 8.

10. The component according to claim 9, wherein the component is a powder metallurgy component chosen from the group consisting of turbine disks and compressor disks and blisks of gas turbine engines.

11. A component formed of the gamma-prime nickel-base superalloy of claim 1.

12. The component according to claim 11, wherein the component is a powder metallurgy component chosen from the group consisting of turbine disks and compressor disks and blisks of gas turbine engines.

13. A gamma-prime nickel-base superalloy consisting of, by weight:
11.9 to 12.7% cobalt;
13.1 to 14.5% chromium;
2.2 to 2.6% aluminum;
3.8 to 5.5% titanium;
3.7 to 4.2% tungsten;
3.1 to 3.6% molybdenum;
0.0 to 1.1% niobium;
0.0 to 2.2% tantalum;
0.0 to 0.5% hafnium;
0.048 to 0.067% carbon;
0.014 to 0.040% boron;
0.041 to 0.070% zirconium;
the balance nickel and impurities, wherein the Nb+Ta content is 0.9-2.2%.

14. The gamma-prime nickel-base superalloy according to claim 13, wherein the titanium content is greater than 4.2%.

15. The gamma-prime nickel-base superalloy according to claim 13, wherein the niobium content is less than 0.5%.

16. The gamma-prime nickel-base superalloy according to claim 13, wherein the tantalum content is at least 1%.

17. The gamma-prime nickel-base superalloy according to claim 13, wherein the hafnium content is greater than 0.3%.

18. The gamma-prime nickel-base superalloy according to claim 13, wherein the gamma-prime nickel-base superalloy consists of, by weight, 11.9 to 12.6% cobalt, 13.1 to 14.5% chromium, 2.2 to 2.6% aluminum, 3.8 to 5.5% titanium, 3.7 to 4.2% tungsten, 3.3 to 3.6% molybdenum, 0.0 to 1.1% niobium, 0.0 to 2.2% tantalum, 0.0 to 0.47% hafnium, 0.048 to 0.067% carbon, 0.014 to 0.033% boron, 0.041 to 0.048% zirconium, the balance nickel and impurities, wherein the Nb+Ta level is 0.9 to 2.2%.

19. A component formed of the gamma-prime nickel-base superalloy of claim 18, wherein the component is a powder metallurgy component chosen from the group consisting of turbine disks and compressor disks and blisks of gas turbine engines.

20. A component formed of the gamma-prime nickel-base superalloy of claim 13, wherein the component is a powder metallurgy component chosen from the group consisting of turbine disks and compressor disks and blisks of gas turbine engines.
